(19) United States
(12) Patent Application Publication
(10) Pub. No.: US 2004/0040368 A1
(43) Pub. Date: Mar. 4, 2004

(54) Apparatus and method for quantity meter testing

(76) Inventors: Carl R. Guckenberger, Mount Dora, FL (US); Dan C. Pinney, Orlando, FL (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/653,339

(22) Filed: Sep. 2, 2003

Related U.S. Application Data
(60) Provisional application No. 60/408,118, filed on Sep. 4, 2002.

(51) Int. Cl. G01F 25/00

(52) U.S. Cl. 73/1.19

(57) ABSTRACT

An apparatus and method that employ a motor control system coupled to a variable positive displacement water chamber system for testing a quantity meter. Using this apparatus and method, the flow rate of water passing through the meter can be positively controlled. The water meter generates an output signal that is monitored by an electronic sensor. The information from the motor controller is compared with the meter output signal to provide a measure of the meter's accuracy.

### CROSS-REFERENCE TO RELATED APPLICATION

The present invention is based on and claims priority to U.S. Provisional Patent Application No. 60/408,118, filed on Sep. 4, 2002.

### FIELD OF THE INVENTION

The present invention relates generally to quantity measurement testing devices, and more particularly, to quickly and accurately testing quantity meters, especially water meters.

### BACKGROUND OF THE INVENTION

Quantity meters are commonly used to measure a liquid's volume. Water meters are one example of a quantity meter. The water that is subject to measurement may flow from a source to a residence or business by way of a water service pipeline. The measurement is usually expressed in cubic feet or gallons.

Measuring water volume has a number of practical uses and advantages. Water meters can be used to measure the amount of water usage for a residence or business, thus allowing the water provider to determine the amount of an invoice for a resident or business. Water meters can also be used as an aid in conserving natural resources by measuring and thus, controlling, the volume of water used for irrigation purposes. Also with respect to irrigation, water volume measurement can be used as an aid to prevent overwatering of produce and crops, thus preventing damage to such produce and crops. This damage prevention allows the producer to enjoy a more profitable business.

Since water meters have such important uses, it is highly advantageous to know that these instruments are accurately measuring the volume of water passing through them. Various systems have been employed to measure the accuracy of these instruments. One example of such a prior art system involves forcing water through a quantity meter and measuring the volume of the water as it exits the meter using a scale or volumetric tank.

This method generally involves an operator flowing water into a tank, where the tank has a known volume. More particularly, the tank is drained and sealed or closed. Then the operator ramps the flow rate to the desired test flow rate, and thereafter, allows the water to flow from the source, through a quantity meter being tested, and into the tank. The water flow is then stopped.

In the case of a tank, the volume is read from the tank by means of a sight glass. In the case of a scale, the volume can be measured since the density of water is known at various temperatures. In both cases, manual calculations are required. The weight of the water as indicated by the scale is converted to volume using the known density of the water at the current temperature. In the case of a tank, manual calculations were then performed to determine the volume recorded by the meter.

The scale and tank systems include inherent inaccuracies. The operator must use large volumes of water to overcome inaccuracies in a scale. For example, if a scale has an error of ±1%, the operator must use a larger weight of water in order to compensate for this inaccuracy. If the tank's meniscus does not accurately show the volume of water in a tank, these inaccuracies are multiplied because the volume measurement is taken at two points: once upon starting water flow, and again upon stopping. These processes are time-consuming, inefficient and are not as accurate as desired.

In order to shorten the amount of testing time, some systems test multiple water meters at the same time, sometimes as few as two water meters in a row, and sometimes as much as one hundred water meters in a row. Such testing systems include multiple pieces, i.e., one test device per water meter aligned in a row. This set-up requires valuable, additional workspace. Moreover, this type of system promotes the practice of an operator waiting until multiple meters are ready and assembled for testing in order to promote efficiency. Increased operator time generally means increased business operating costs. A need exists for a water meter testing device that is comprised of a single unit, and that can accurately test water meters. A need exists for such a testing device that does not require much operator time for each meter test.

Flow rate control is yet another important aspect of quantity meter testing. The flow rate should be constant in order to provide an accurate test. Some prior art testing devices attempt to address flow rate concerns by employing a fairly complex system of variable speed pumps and computer controls. In some cases, a water tower is used. These prior art systems tend to be expensive and require a large amount of space.

### SUMMARY OF THE INVENTION

The present invention solves the problems set forth above by providing an accurate testing device for quantity water meters that can test multiple meters in a shortened time frame.

The present invention provides an apparatus and method that employs a motor control system coupled to a variable positive displacement water chamber system. Using this apparatus and method, the flow rate of water passing through the meter can be positively controlled. The water meter generates an output signal that is monitored by an electronic sensor. The information from the motor control system is compared with the meter output signal. Both the motor controller and the meter output sensor are of a high speed and accuracy, thereby providing for accurate meter testing.

An advantage of the present invention is to provide more accurate test results using smaller test volumes than current test devices allow. The operator is not required to compensate for errors associated with a scale or a tank's meniscus as set forth hereinabove. The present invention provides a method whereby only a small quantity of water must be used upon ramping the device to the required speed.

Embodiments of the present invention provide a device that provides a constant flow rate for testing quantity meters. The present invention provides a testing device that includes a servo motor for controlling flow rate. The motor provides a means for displacing water from a water chamber and into a quantity meter, thus providing a constant flow rate. A constant flow rate increases the accuracy of the system, thereby providing reliable results.

Another advantage of the present invention is the automation of the testing device, reducing operator time. The present invention does not require as much operator time as many prior art systems since, in one embodiment of the present invention, the operator is only required to clamp the quantity meter to the test. The test device provides the constant flow rate and performs the necessary calculation. Because of this reduced operator time, businesses are able to reduce operating costs.

Also, the test device of the present invention does not require much valuable workspace. The present invention requires much less space than many prior art systems, thus allowing the space to be used for other purposes.

Additional aspects, advantages and novel features of the embodiments will be set forth in part in the description which follows, and in part will become apparent to those skilled in the art upon examination of the following and the accompanying drawings or may be learned by practice of the invention.

Various other features, objects and advantages of the invention will be made apparent from the following description taken together with the drawings.

### BRIEF DESCRIPTION OF THE DRAWINGS

The drawing figures depict preferred embodiments by way of example, not by way of limitation. In the drawings:

FIG. 1 is a schematic diagram illustrating a side view of one embodiment of the apparatus for testing water meters in the initial test preparation stage.

FIG. 2 is a schematic diagram illustrating a more detailed side view of the apparatus for testing water meters.

FIG. 3 is schematic diagram illustrating a side view of one embodiment of the apparatus for testing water meters in the clamping and purging stage, the next preparatory stage for meter testing.

FIG. 4 is schematic diagram illustrating a side view of one embodiment of the apparatus for testing water meters in the testing stage.

FIG. 5 is a schematic diagram illustrating a top view of one embodiment of the apparatus for testing water meters.

FIG. 6 is schematic diagram illustrating a side view of one embodiment of the apparatus for testing water meters when the test is complete.

### DETAILED DESCRIPTION OF THE INVENTION

The present invention provides an apparatus and method for testing water flow measurement devices with a high degree of accuracy and repeatability.

The present invention is used for testing quantity meters to monitor accuracy and reliability. Although the description will largely relate to water meters, the present invention can be used to test any quantity meter that measures liquid volume. For example, the present invention could also be used to test other liquid quantity meters, e.g., oil quantity meters. The method employed in connection with the test apparatus is described generally in steps A through D.

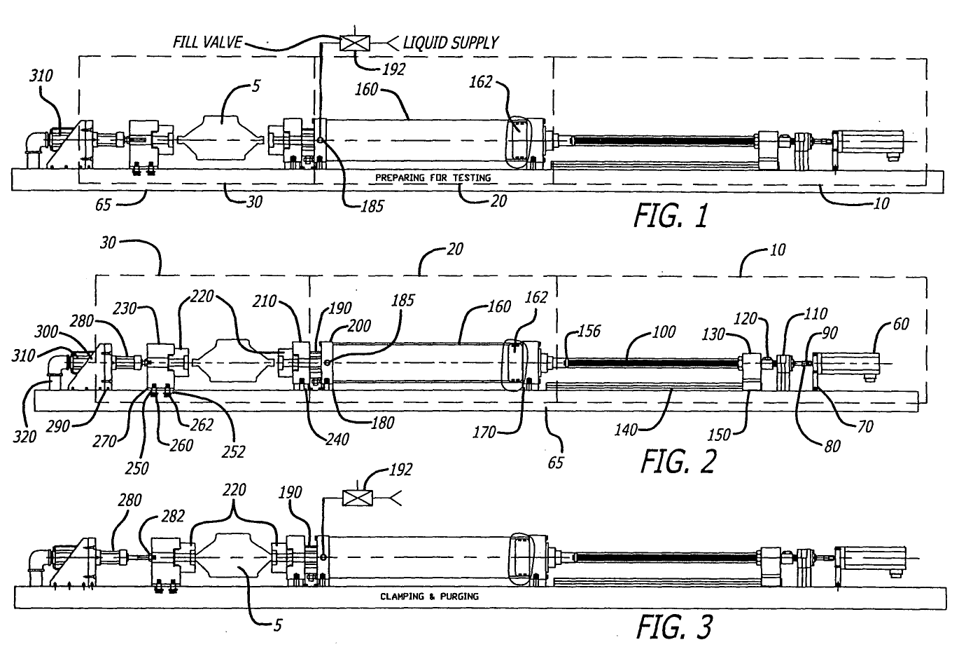

A. Preparing for Testing. Referring now to FIG. 1, one embodiment of the testing apparatus is illustrated in a side view. The testing apparatus includes a motor control system 10 that is operatively coupled to a variable positive displacement water chamber system 20 that is further operatively coupled to a clamp assembly system 30 that allows for mounting of the test meter 5. Check valve 310 is an optional device that provides back pressure to promote better meter performance and prevents undesired water drainage. The motor control system 10, the variable positive displacement water chamber system 20 and the clamp assembly system 30 are mounted on channel 65. The channel 65 is preferably made of aluminum. Although a single support device in the form of a channel is illustrated in the preferred embodiment, the invention can be practiced with multiple support devices.

B. Securing the Quantity Meter to the Test Device. Referring now to FIG. 2, illustrated is a detailed side view of the test apparatus. Water must be inserted into water cylinder 160 in order for the testing apparatus to operate. Water may be inserted into fill port 185 located on the cylinder end cap 200 of water cylinder 160. A water supply such as a tube may be used to input water into the fill port 185. Water cylinder 160 is filled with a liquid and the piston 162 is fully retracted to the illustrated position shown by the cut-out section of FIG. 2.

The test meter 5 may be secured to the single piece-test apparatus via the clamp assembly system 30. This particular clamp assembly system 30 includes an adapter 220, a clamp assembly base plate 210, clamp assembly base plate spacer 240, clamp assembly slide plate 230, two washers 250, 252, two shoulder bolts 260, 262, double acting clamp cylinder 280, cylinder mounting plate 290 and cylinder mounting plate support 300.

Adapter 220 allows test meters of different sizes to be mounted for testing purposes. When the size of a test meter changes, the size of adapter 220 can also be changed to accommodate larger or smaller test meters. This particular embodiment of the clamp assembly system 30 shown in FIG. 2 is particularly suitable for testing the common water meter sizes of ¾ inch, ⅝ inch, and 1 inch. These measurements generally relate to the size of the outer thread of the opening at the end of the test meter 5. Although the preferred embodiment is particularly suitable for use with test meters of various specific sizes, the present invention can be adapted for test meters of many sizes.

The operator may insert adapter 220 between the clamp assembly base plate 210 on one end and the clamp assembly slide plate 230 on the other end to accommodate various quantity meter sizes. Clamp assembly base plate 210 is mounted on clamp assembly base plate spacer 240 which is, in turn, mounted on channel 65. The spacer 240 provides room between test meter 5 and channel 65 so that the test meter 5 is not obstructed by channel 65. Spacer 240 also substantially aligns the horizontal center of test meter 5 with the horizontal center of water cylinder 160, thus providing for accurate input of water into test meter 5.

Clamp assembly slide plate 230 is mounted on a plate 270 preferably formed from an ultrahigh molecular weigh plastic, which is, in turn, mounted on channel 65. Both the clamp assembly slide plate 230 and the plate 270 have holes bored therethrough so that they can be mounted on channel 65, two washers 250, 252 being insertable through the clamp assembly slide plate 230. Just below the washers 250, 252 shoulder bolts 260, 262 secure the washers 250, 252, through plate 270 and clamp assembly slide plate 230.

Clamp assembly slide plate 230 includes a hole bored therethrough for double acting clamp cylinder 280 so that double acting clamp cylinder 280 can be inserted therethrough. Double acting cylinder 280 is mounted on one end by clamp assembly slide plate and on the other end by cylinder mounting plate 290. Double acting clamp cylinder 280 operates as an aid in supplying pressure against the test meter 5 by extending so that the smaller test meters are accommodated, and retracting so that larger meters are accommodated. Cylinder mounting plate 290 is supported by cylinder mounting plate support 300 which extends upward from the channel 65. Cylinder mounting plate support 300 also includes an air cylinder that aids in adjustment for the size of the meter as set forth in more detail with respect to FIG. 5 hereinbelow. Check valve 310 is coupled to a pipe 320 which extends downward to channel 65.

Referring now to FIG. 3, illustrated is a side view of the testing apparatus during the clamping and purging stage. Clamp cylinder 280 forms a seal 282 between the adapter 220 and test meter 5 so that water does not escape from the test apparatus during the upcoming test process. The inlet valve 190 is opened and the fill valve 192 is opened, thus allowing liquid to flow through the meter 5. A drain valve (not shown) may be used as an aid in this operation by allowing water to flow and out of the drain and to purge air out of the meter before the test.

C. Testing. Once the test meter has been secured by the clamp assembly system 30 and water has been inserted into fill port 185, the fill valve 192 is closed.

Referring back to FIG. 2, the servo motor 60 is set to rotate at a specified speed. The servo motor 60 is a part of the motor control system 10 that also includes a motor mount 70 that is mounted on channel 65. Also included in the motor control system 10 is the output shaft 80 of servo motor 60 coupled to lead screw 100 by coupling 90. Lead screw 100 is mounted on lead screw bearing block 110. Lead screw 100 is enclosed in a shaft that is connected to the piston 162 of the water cylinder 160, thus allowing the motor to control the lead screw's advancement toward the piston 162. The motor control system 10 also includes transition block 130 having a linear guide 150 underneath for moving along linear guide track 140, so that transition block 130 can move toward piston 162.

The motor 60 may be a DC servomotor. Some standards require quantity meter testing at a particular flow rate, and the motor speed can be controlled such that the flow rate of water is controlled with high accuracy. The motor includes a register for assisting with calculations related to determining the accuracy of the test meter. Water flow can be controlled by the speed of the motor 60 which pushes the lead screw 100 into the water cylinder 160. The water flows into the test meter 5 at the rate it is pushed through water cylinder 160, such that a specific flow rate is established through test meter 5.

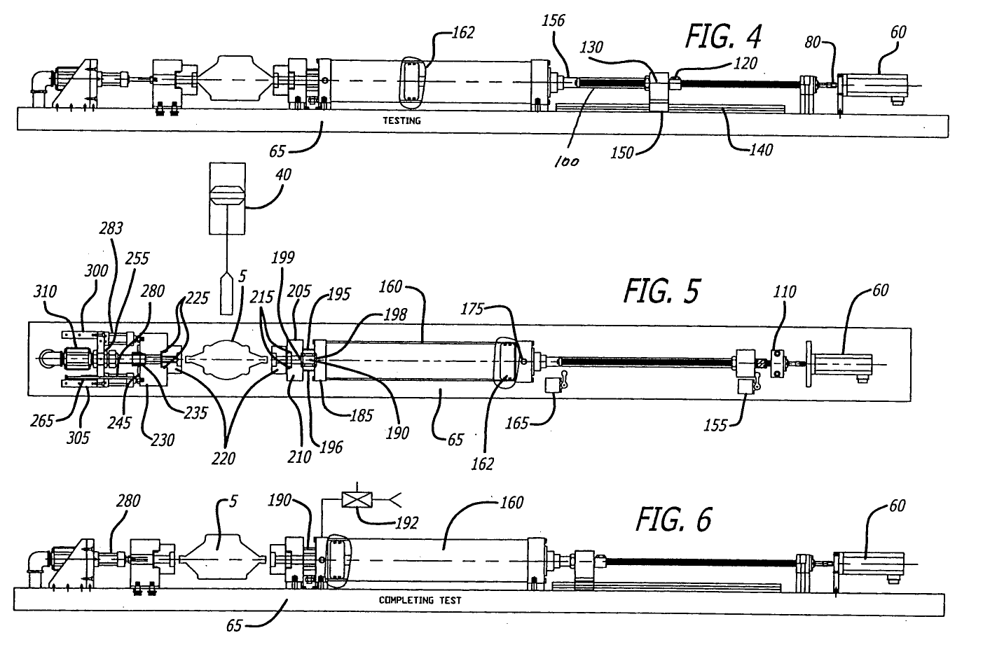

Referring now to FIG. 4, as the output shaft 80 of motor 60 turns, the lead screw 100 advances toward the variable positive displacement water chamber system 20. As lead screw 100 advances, the transition block 130 on which lead screw 100 is mounted, moves along with the lead screw 100. A lead screw ball nut 120 secures lead screw 100 to transition block 130.

Transition block 130 moves along with lead screw 100 under control of the motor 60 toward the cylinder 160, thus accomplishing variable positive water displacement in cylinder 160. Linear guide 150 has a square bottom with grooves on all four sides of the bottom. Linear guide 150 fits snugly enough within guide track 140 so that the guide 150 does not slip from the guide track 140, but allows motion that is free enough such that guide 150 can slide freely along track 140. Guide 150 also has a slippery plastic lining that matches the grooves in track 140. This assembly allows rotary motion to be translated through lead screw 100 as opposed to rotary motion being translated through transition block 130.

Near the end of the screw 100 closest to piston 162, a second guide 156 is mounted on the screw thus aiding in guiding the length of the screw 100 toward variable positive displacement water chamber 20. This guide 156 is enclosed in a shaft that is connected to the piston 162 of water cylinder 160. In this view in FIG. 4, the piston 162 has advanced to displace water from cylinder 160.

Now referring back to FIG. 2, variable positive displacement water chamber system 20 includes a water cylinder 160 having a piston 162 therein. The piston 162 may be a solid cylinder or disk that fits snugly into water cylinder 160 as long as it displaces the water that has been input. Water cylinder 160 is mounted on two cylinder end cap spacers 170, 180, each cylinder end cap spacer being mounted onto channel 65. Cylinder end cap spacer 170 shown near the right end of water cylinder 160, as well as cylinder end cap spacer 170 shown near the left end of water cylinder 160, lend space between the water cylinder 160 and channel 65 so that water cylinder 160 can operate freely without being obstructed by channel 65.

The end cap spacers 170, 180 also allow the horizontal center of cylinder 160 to be substantially horizontally aligned with the horizontal center of test meter 5 on one end and the horizontal center of lead screw 100 on the other end. The spacers 170, 180 could be heightened or lowered to accommodate various set-ups depending on the height of other parts used.

Variable positive displacement water chamber system 20 also includes inlet valve 190 that allows water to be filled into cylinder 160 without draining. The inlet valve 190 permits fluid passage from the water cylinder 160 when water is being filled into the cylinder 160 through fill port 185. Inlet valve 190 prevents water passage from the cylinder 160 during the test process.

Referring now to FIG. 5, illustrated is a top view of the test apparatus in one embodiment of the present invention. Electronic sensor 40 produces a signal that can be read by the register of motor 60 during the test process. The sensor 40 can be an optical sensor, a magnetic sensor or any other device that produces a signal that can be read by the motor 60. The type of sensor used depends largely upon the type of test meter 5. The sensor 40 should have the capability to read the test meter 5 without operator assistance. For magnetic test meters, a magnetic sensor may be used in order to read the test meter's proposed volumetric measurement. For test meters using wheels or impellers that rotate and display measurement, an optical sensor may be used.

The register of motor 60 reads these sensor signals as “pulses” that indicate the rotations of the test meter 5. When the speed of the motor 60 is established, and thus a constant flow rate of water through cylinder 160, the register of motor 60 memorizes the location of the piston 162 at the next meter pulse. After a preset number of pulses has been received, the motor's register determines the position of the piston 162 on the next pulse. The first position of the piston 162 is subtracted from the second position of the piston 162. When this distance, i.e., the distance the piston 162 has advanced, is compared with the known volume of cylinder 160, it provides the actual amount of liquid that passed through the test meter 5 from the first pulse to the last pulse. This amount is the test volume. Software may be used to perform the calculation for the test volume. The calculation may also be performed manually and/or using a calculator.

Each pulse from the electronic sensor 40 represents a specific quantity that was measured by the meter 5. The number of pulses multiplied by the quantity represented by each pulse produces the measured volume. When the test volume is compared to the volume measured by the meter 5, the accuracy of the volume measured by the meter 5 can be determined. Software may be used to determine the measured volume of the meter; the software may also be used to compare the test volume to the measured volume, thus determining the test meter's accuracy. The calculation may also be performed manually and/or using a calculator.

Attached to transition block 130 is an extended limit switch 155 that limits the extension of the screw 100 into lead screw bearing block 110. This feature is a safety measure to stop the screw 100 from retracting into the motor 60. On the other hand, retracted limit switch 165 limits the extension of lead screw 100 in the direction of water cylinder 160 during the test process, which has now been completed. Vent pressure test port 175 allows the pressure to vent from cylinder 160.

Four stainless steels rods 195, 196, 198, and 199 are located between drain port 205 and fill port 185. Drain port 205 allows water to drain from water cylinder 160. Drain port 205 has locking pins 215 secured on the outside of clamp assembly base plate 210 for securing the end of adapter 220 to drain port 205 and to prevent rotation of adapter 220. Adapter 220 is mounted on the other end by clamp assembly slide plate 230 which also has locking pins 225 attached thereto for securing the adapter 220 to the clamp assembly slide plate 230, thus preventing rotation of the adapter 220.

Double acting clamp cylinders 280, 283 are mounted on the end closest to water cylinder 160 by gland 235 and gland mounting bracket 245. Two double acting clamp cylinders 280, 283 are mounted on the other end to cylinder mounting plate supports 300, 305 which extend back on both sides of check valve 310 from double acting clamp cylinders 280, 283. A “no meter” limit switch 265 operates to limit the extension of clamp cylinder. The “no meter” limit switch 265 is generally located at such a position that the smallest test meter suitable for the testing device is not exceeded by extension of the clamp cylinder 280.

D. Completing the test. Referring now to FIG. 6, when the test is complete, the inlet valve 190 is closed. Clamp cylinders 280, 283 are retracted, thus allowing the meter 5 to be removed. The fill valve 192 is opened and the motor 60 is reversed. The cylinder 160 can now be filled with liquid in preparation for subsequent testing. After the test is complete, the piston 162 is retracted for the fully extended position of FIG. 6 to the retracted position of FIG. 2.

As the present invention may be embodied in several forms without departing from the spirit or essential characteristics thereof, it should also be understood that the above described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

Various alternatives and embodiments are contemplated as being within the scope of the following claims particularly pointing out and distinctly claiming the subject matter regarded as the invention.

We claim:

1. An apparatus for testing quantity meter devices, the apparatus comprising:
clamp device for securing a quantity meter;
a variable positive displacement water chamber device in fluid communication with the quantity meter for passing fluid through the quantity meter, wherein the water chamber device has a known volume;
a motor control device operatively coupled to the variable positive displacement water chamber device such that the motor control device controls the displacement of the fluid from the water chamber device through the quantity meter, the motor control device including a register device operable to selectively determine the amount of fluid dispensed from the water chamber;
an electronic sensor device for measuring an output signal from the quantity meter, where each of the output signals from the quantity meter represent a measurement of the quantity meter; and
a calculation device coupled to both the register device and the electronic sensor device, wherein the calculation device is operable to determine a test volume based on the register device and a measured volume based on the output signals from the electronic sensor device.

2. The apparatus of claim 1 wherein the clamp device further comprises a slide plate movable toward and away from the variable positive displacement water chamber device such that the clamp device is adjustable to secure different sized quantity meters.

3. The apparatus of claim 2 wherein the clamp device further comprises a clamp cylinder coupled to the slide plate for moving the slide plate toward and away from the variable positive displacement water chamber device, wherein the clamp cylinder is operable to exert pressure to force the quantity meter into a fluid tight communication with the water chamber device.

4. The apparatus of claim 3 wherein both the water chamber device and the slide plate include an adapter for receiving the quantity meter, wherein each adapter forms a fluid tight seal with the quantity meter.

5. The apparatus of claim 1 wherein the variable positive displacement water chamber device comprises a cylinder and a piston movable within the cylinder, the cylinder having a known volume.

6. The apparatus of claim 5 wherein the motor control device is operatively coupled to the piston device such that the motor control device moves the piston in the cylinder to displace fluid from the cylinder.

7. The apparatus of claim 6 wherein the motor control device includes a drive motor rotatably coupled to a lead screw, wherein the lead screw is coupled to the piston such that rotation of the lead screw moves the piston along the length of the cylinder to dispense fluid from the cylinder.

8. The apparatus of claim 5 wherein the register device is operable to determine the position of piston within the cylinder.

9. The apparatus of claim 8 wherein the register device monitors the rotation of the motor to determine the position of the piston within the cylinder.

10. The apparatus of claim 5 wherein the calculation device determines the test volume based upon the movement of the piston within the cylinder.

11. The apparatus of claim 1 further comprising a single support device for securing the clamp device, the variable positive displacement water chamber device, the motor control device, and the electronic sensor device.

12. The apparatus of claim 1 wherein the variable positive displacement water chamber device includes a fluid inlet for receiving a supply of fluid, the supply of fluid being discharged from the water chamber device through the quantity meter.

13. An apparatus for testing quantity meter devices, the apparatus comprising:
a clamp device for securing a quantity meter;
a variable positive displacement water chamber device in communication with the quantity meter being tested, the water chamber device being operable to pass fluid through the quantity meter, wherein the variable positive displacement water chamber device includes a piston movable within a cylinder, the cylinder having a known volume;
a motor control device operable to move the piston within the cylinder, the motor control device being operatively coupled to the piston such that when force is applied to the piston, the piston moves within the cylinder to displace fluid from the cylinder and through the quantity meter, when the motor control device includes a register operable to determine the position of the piston within the cylinder;
an electronic sensor for measuring an output signal from the quantity meter, the electronic sensor being operatively coupled to the motor control device to transmit signals to the motor control device, wherein each signal represents a measurement of the quantity meter; and
a calculation device for determining a test volume from the register device and a measured volume based on the signal from the electronic sensor device.

14. The apparatus of claim 13 wherein the clamp device further comprises a slide plate movable toward and away from the variable positive displacement water chamber device such that the clamp device is adjustable to secure different sized quantity meters.

15. The apparatus of claim 14 wherein the clamp device further comprises a clamp cylinder coupled to the slide plate for moving the slide plate toward and away from the variable positive displacement water chamber device, wherein the clamp cylinder is operable to exert pressure to force the quantity meter into a fluid tight communication with the water chamber device.

16. The apparatus of claim 15 wherein both the water chamber device and the slide plate include an adapter for receiving the quantity meter, wherein each adapter forms a fluid tight seal with the quantity meter.

17. The apparatus of claim 13 wherein the motor control device includes a drive motor rotatably coupled to a lead screw, wherein the lead screw is coupled between the drive motor and the piston such that rotation of the drive motor moves the piston along the length of cylinder.

18. The apparatus of claim 13 wherein the variable positive displacement water chamber device includes a fluid inlet for receiving a supply of fluid, the supply of fluid being discharged from the water chamber device through the quantity meter.

19. The apparatus of claim 13 wherein the register device is coupled to the drive motor such that the register device monitors the rotation of the drive motor.

20. The apparatus of claim 13 further comprising a support device for securing the clamp device, the variable positive displacement water chamber device, the motor control device and the electronic sensor device.

21. The apparatus of claim 13 wherein the quantity meter is a water meter.

22. A method for testing quantity meters, the method comprising steps of:
securing a quantity meter to a clamp device;
moving the quantity meter into fluid communication with a variable positive displacement water chamber device, wherein the variable positive displacement water chamber device includes a piston movable within a cylinder, the cylinder having a known volume;
filling the cylinder with the known volume of fluid;
advancing the piston by activating a motor control device coupled to the piston, wherein when force is applied to the piston, the piston displaces fluid from the cylinder through the quantity meter;
monitoring the position of the piston within the cylinder such that a test volume can be determined;
positioning an electronic sensor to measure an output signal of the quantity meter as fluid is passed through the quantity meter, wherein the electronic sensor is coupled to the motor control device and transmits signals to the motor control device;
determining a measured volume of fluid that has passed through the quantity meter based upon the signals from the electronic sensor; and
comparing the determined measured volume to the determined test volume.

23. The method of claim 22 further comprising the step of positioning the quantity meter in the clamp device and moving the clamp device to engage the quantity meter with the variable positive displacement water chamber device.

24. The method of claim 23 wherein the clamp device includes a clamp cylinder, the clamp cylinder being extendable and retractable to move the quantity meter toward and away from the variable positive displacement water chamber device.

25. The method of claim 22 wherein the motor control device includes a drive motor and a lead screw, the lead screw being positioned between the drive motor and the piston such that rotation of the drive motor advances the piston along the cylinder.

26. The method of claim 22 further comprising the steps of:
determining the position of the cylinder upon receiving a first output signal from the electronic sensor;
determining the position of the piston upon receipt of a second output signal from the electronic sensor;
determining a test volume based upon the movement of the piston within the cylinder and the known volume of the cylinder; and
determining the measured volume based upon the first and second test signals received from the quantity meter.

27. The method of claim 22 further comprising the step of securing the clamp device, the variable positive displacement water chamber device, the motor control device and the electronic sensor to a single support device.

28. The method of claim 22 wherein the step of inserting fluid into the cylinder includes opening an inlet valve to supply fluid to the cylinder, wherein the inlet valve presents the discharge of the fluid through the inlet valve.

29. The method of claim 22 wherein the step of securing the quantity meter to a clamp device comprises inserting the quantity meter into a first adapter formed on the variable positive displacement water chamber device and a second adapter formed on the clamp device, wherein each of the adapters provide a fluid tight seal with the quantity meter.

30. The method of claim 22 wherein the quantity meter is a water meter and the fluid is water.
